(19) United States
(12) Patent Application Publication
(10) Pub. No.: US 2013/0324146 A1
(43) Pub. Date: Dec. 5, 2013

(54) METHOD FOR TRANSMISSION OF LOCATION INFORMATION

(71) Applicant: Arttu YLARAKKOLA, Helsinki (FI)

(72) Inventor: Arttu YLARAKKOLA, Helsinki (FI)

(73) Assignee: RAKETTITIEDE OY, Helsinki (FI)

(21) Appl. No.: 13/483,276

(22) Filed: May 30, 2012

(51) Int. Cl. H04W 24/00

(52) U.S. Cl. 455/456.1

(57) ABSTRACT

The invention relates to communicating location information to mobile devices for display to the users of the mobile devices. An advantageous embodiment of the invention provides method in a server node for communicating location specific information between the server node and a mobile device, comprising at least the steps of receiving at least one request from the mobile device, extracting at least one identifier of a location item channel from a received request, and transmitting to the mobile device at least one location item from a location item channel whose identifier was extracted from a received request.

### FIELD OF THE INVENTION

The invention relates to communicating location information to mobile devices for display to the users of the mobile devices. Especially, the invention is related to such a method as specified in the preamble of the independent method claim.

### BACKGROUND

Mobile devices such as cellular phones, tablets, and other types of small computers are ubiquitous today. Map applications and navigation software are also common on such devices, and are often installed by default on many brands of cellular phones. Since satellite navigation functionality, such as GPS fuctionality is a typical feature of such devices, these devices perform well as navigation devices. Users can add their favourite locations in a typical map application, by marking a certain location, giving it a name and possibly a short description. Map applications also typically have various categories of places of interest, which the user can select to be shown on the map.

However, the known solutions do not make it simple to add an item found while working on a desktop computer into a map application on the mobile device of the user. It is also difficult to share location information between individuals, or publish location information for a plurality of users in an easy way.

### SUMMARY

The present invention seeks to address at least some of the problems outlined above.

According to first aspect of the invention, a method in a server node is provided. The method is characterized by that, which is specified in the characterizing part of the independent method claim directed to a method in a server node.

According to a second aspect of the invention a server node is provided. The server node according to the invention is characterized by that, which is specifled in the characterizing part of the independent claim directed to a server node.

According to a further aspect of the invention, a computer readable medium carrying one or more sequences of one or more instructions is provided.

According to a further aspect of the invention, a method in a mobile device is provided. The method is characterized by that, which is specified in the characterizing part of the independent method claim directed to a method in a mobile device.

According to a further aspect of the invention, a mobile device is provided. The mobile device is characterized by that, which is specified in the characterizing part of the independent claim directed to a mobile device.

According to a further aspect of the invention, a computer readable medium carrying one or more sequences of one or more instructions for execution in a mobile device is provided.

The dependent claims describe further advantageous embodiments of the invention.

### BRIEF DESCRIPTION OF THE DRAWINGS

Various embodiments of the invention will be described in detail below, by way of example only, with reference to the accompanying drawings, of which

FIG. 1 illustrates various embodiments of the invention,

FIG. 2 illustrates a method in a server node according to an aspect of the invention,

FIG. 3 illustrates a a computer readable medium according to a further aspect of the invention carrying one or more sequences of one or more instructions,

FIG. 4 illustrates a method in a mobile device according to a further aspect of the invention,

FIG. 5 illustrates a mobile device according to a further aspect of the invention, and

FIG. 6 illustrates a a computer readable medium according to a further aspect of the invention carrying one or more sequences of one or more instructions.

### DETAILED DESCRIPTION OF CERTAIN EMBODIMENTS

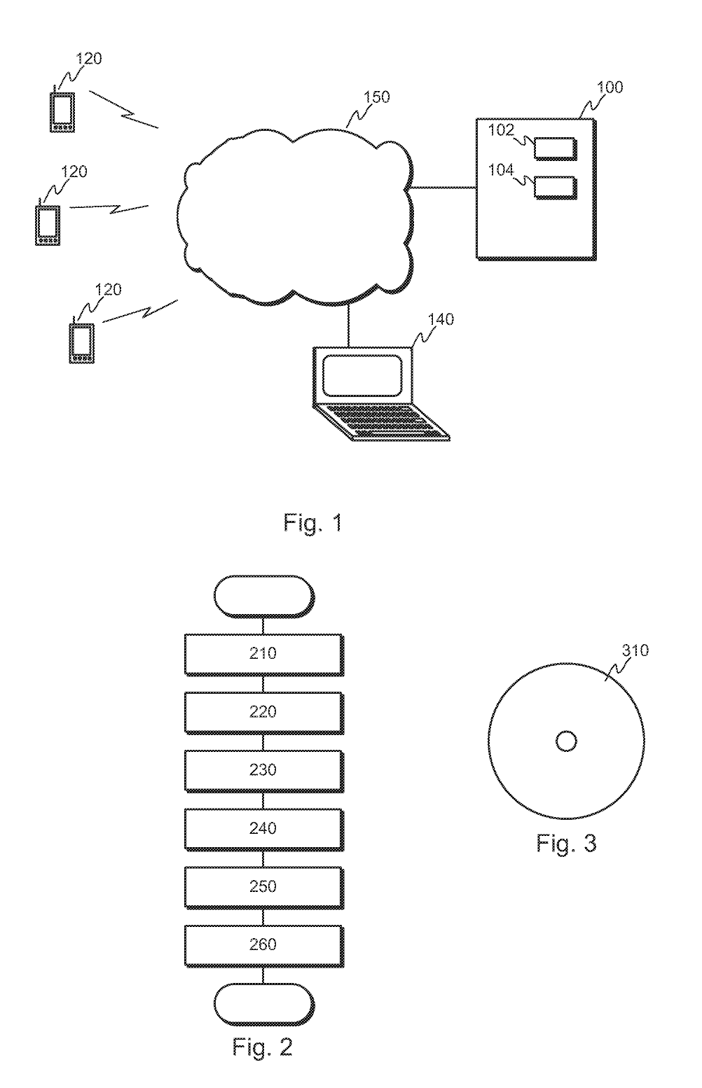

FIG. 1 illustrates various embodiments of the invention. FIG. 1 shows a server node 100, mobile devices 120, computer nodes 140, and a communications network 150 allowing communication between these entities. The server node 100 comprises at least one controller 102 and memory means 104.

In an advantageous embodiment of the invention the mobile devices 120 receive location items from the server node by periodically or aperiodically transmitting a request to the server node, including the current location of the mobile device in the request. After receiving the request, the server node 100 checks whether there are any location item channels associated with a geographical area covering the location indicated in the request. If there are such channels, the server node indicates the identifiers of such channels in a response message to a mobile device.

In a further embodiment of the invention a location item channel is associated with information indicating whether the channel is private or non-private. If the channel is indicated to be private, the server node provides information about the channel or location items from that channel only as a response to a request specifying the identifier of that channel. If a channel is indicated to not be private, the server node provides information about the channel or location items from that channel as a response to a request from any mobile device within the geographical area associated with the channel.

In a further embodiment of the invention, the server node performs the checking of availability of location item channels if a request from the mobile device does not contain a location item channel identifier. In an even further embodiment of the invention, the server node performs the checking of availability of location item channels as a response to a specific request from a mobile device requesting such a check.

In a further embodiment of the invention, a mobile device includes at least one location item channel identifier in the request. Upon receiving the request, the server node 100 checks whether there are location items corresponding to the identified location item channel, and if such items are found, they are transmitted to the mobile device in a response message. The mobile device may also indicate in the request the identifier of the latest location item which the mobile device has received from the server node or for example an indication of a timestamp of the latest update of location items, which allows the server node to check whether there are any new, updated or deleted location items in the identified channel and if any are found, to send information about only those.

In a further embodiment of the invention, if the mobile device did not include a location item channel identifier in the request message to the server node, the server node creates a location item channel for use by that mobile device, and returns the identifier of the created location item channel to the mobile device in a response message. This new location item channel can advantageously be specified to be private. Such an embodiment provides the advantage that after quickly the first start of client software in the mobile device and subsequent exchange of a request and a response, the client software of the mobile device can indicate a location item channel identifier for the user, who can thereafter use the identifier for transmitting location items to his mobile device.

In a further advantageous embodiment of the invention the location item channel identifier can be an identifier associated with the mobile device, such as a telephone number or for example a hardware identifier such as an IMEI (International Mobile Equipment Identity) identifier, or for example an identifier provided by the user, or for example an identifier formed from coordinates of the mobile device. In such an embodiment of the invention the server node does not assign location item channel identifiers, but rather each mobile device informs the server of its identifier to be used as a location item channel identifier.

In a further embodiment of the invention, a mobile device sends an initialization message to the server node at the startup of the client software in the mobile device. As a response to the initialization message the server node creates a new device identifier and sends the new identifier in a response message to the mobile device. In this embodiment, if the mobile device already has a previously assigned device identifier, the mobile device ignores the new identifier, but if the mobile device does not have a device identifier, the mobile device stores the device identifier for later use as the device identifier of the mobile device. Such an embodiment has the advantage, that during the initial start-up of the client software in the mobile device, the user does not need to enter any specific identification information, since the server node automatically assigns a device identifier to the mobile device.

In a further embodiment of the invention, the server node creates a device identifier for a mobile device and transmits the created device identifier in a response message to the mobile device, if a request from the mobile device did not indicate a device identifier.

A server node can be implemented in many different ways, as is evident to a man skilled in the art. The server node can be for example a single computing device, or for example a group of computing devices for providing a higher capacity. The server node can also be a virtual server being executed as one of a plurality of virtual servers on a physical host computing device. The server node can also be implemented as a plurality of virtual servers on a plurality of physical servers which may even be geographically distributed. Further, in a case where the server node is constructed using a plurality of physical or virtual servers, the tasks described in this description as being performed by a server node can be divided in many different ways among the plurality of physical or virtual servers. The invention is not limited to any particular way of structuring a server node.

In a further advantageous embodiment of the invention, a user can input location items from his mobile device or, even more advantageously, from another computer node. Such functionality allows the user to conveniently add locations of interest to his mobile device while for example browsing the internet on his desktop computer. In such an embodiment the server node is configured to receive information about a location as well as a channel identifier from a computer node, and to provide the received information as a location item via the identified location item channel.

In an advantageous embodiment of the invention, the server node is also arranged to provide code to a computer node for displaying an user interface or a part of an user interface such as a window to a user for inputting information about a location. This computer code can be for example HTML code defining a window, and may include one or more scripts such as Javascript scripts or the like to help the user e.g. by prefilling a field in the user interface or a part of it.

The user can enter the channel identifier into such an interface in order to input the location into the desired channel. In a further embodiment a script in the computer code can read a previously stored channel identifier from the computer node. As an example of one technology prevalent at the time of writing this patent application, the user interface or part of it such as a window can be composed of HTML code with associated Javascript scripts, and the computer code can read a previously stored cookie containing a channel identifier. However, as is evident to a man skilled in the art, the storage and retrieval of a channel identifier (or any other locally stored pieces of information) at a computer node can be implemented in many different ways, and the invention is not limited to any particular implementation of local storage.

In the following example we describe an exemplary scenario of how a user can start transferring location items to his mobile device in an advantageous embodiment of the invention. The user starts a client software on his mobile device. The client application directs the mobile device to transmit a request to the server node. Since in this example this request is the first one of the first use of the application, the client software does not know a channel identifier, and therefore does not include a channel identifier in the request. The server node receives the request, and as a response to determining that there is no channel identifier in the request, the server node creates a channel identifier for that mobile device, and transmits the channel identifier to the mobile device in a response message. The mobile device can then display the channel identifier to the user, who can then start transferring information about locations to his mobile device using this channel identifier.

The client software on a mobile device or a computer node can be for example a native application requiring installation prior to use. The client software can also be an applet or a script obtained from a web page and being executed on the mobile device.

The client software advantageously uses GPS location functionality or other location and/or navigation functionality, if such functionality is provided by the mobile device. However, the client software can also use other sources of information for reporting a location as the location of the mobile device to the server node. For example, if the client software provides a map interface to the user, the client software can report a location from the area displayed by the map interface as the location of the mobile device to the server node. As another example, the client software can receive an indication from the user about a desired location such as the name of a town, and base the location reported as the location of the mobile device on that information. In this way the location indicated by the mobile device as its location to the server node need not be the true location of the mobile device. Such functionality in the client software allows the use of the inventive system using also non-mobile computer nodes, for example for browsing places of interest in a desired area.

In a further embodiment of the invention, the server node provides an application program interface (API) for other computer systems to connect to for inputting, reading, updating or deleting location items.

In a further advantageous embodiment, the server node can provide code to a computer node for displaying an user interface or a part of it as a response to a request from the computer node. This request can include information to be prefilled to the user interface; such as location (for example as an address, or as some other indication of physical location, or as coordinates) and/or a description for the location. Such functionality allows websites provide a button or a similar user interface object beside a location of interest, and by clicking the button the users can initiate adding the location of interest to a location item channel whose location items they can then subsequently view on their mobile devices. In a further embodiment of the invention, if the information to be prefilled includes the location, a description and also the channel identifier, the server node can elect to provide a location item to the identified channel based on the information in the request without even providing an user interface or a part of it for display to the user.

In an advantageous embodiment of the invention, a mobile device can send a request to the server for creating a new location item channel. As a response to receiving such a request, the server node creates a location item channel and transmits the identifier of the new location item channel in a response message to the mobile device.

In a further advantageous embodiment of the invention, a mobile device can send a request for deletion of a location item. Preferably, the server node performs a check of whether the requesting mobile device is allowed to delete the particular location item. This can be performed for example based on the owner of the channel with which the location item is associated: if a device—whether a mobile device or a computer node—is indicated to be the owner of the channel, the server node can for example allow deletion requests from the owner device only. The ownership of a channel can be indicated for example with a mobile device identifier.

In a further embodiment of the invention, the server node 100 can select which location items to transmit to a mobile device on the basis of the distance between the location of the mobile device and the location associated with each location item. For example, the server node can select items whose locations are closer to the mobile device than a predetermined distance. As a further example, the server node can also select to send a predetermined number of nearest items. Such an embodiment is advantageous for example for providing location item channels, which provide a large number of location items from a large geographical area.

The geographical area associated with a channel can be specified in many different ways. For example, the geographical area can be indicated by a location and a predetermined radius of an area around the location, or for example by a plurality of locations and corresponding radiuses. The predetermined radius can be a general default value, or for example a value associated with the particular channel, or associated with a specific location associated with the particular channel. Further, the geographical area can be indicated by indicating a plurality of locations defining the border of the area. Even further, the geographical area can also be specified to be global, i.e. not tied to any particular location. In a further embodiment of the invention, the server node can select which location item channels to indicate to a mobile device on the basis of the distance from the location of the mobile device to a location associated with a channel. For example, the server node can select to indicate to a mobile device a predefined number of channels, whose associated locations are closest to the mobile device.

The communications network 150 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The mobile device 120 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), a game device, or any combination thereof.

The mobile devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A mobile device involved in implementing various embodiments of the present invention may communicate using various media including, but not limited to, radio, infrared, laser, cable connections, and any suitable connection.

FIG. 2 illustrates a method according to a further aspect of the invention. According to this aspect of the invention, a method in a server node for communicating location specific information between the server node and a mobile device is provided. The method comprises at least the steps of

receiving 210 at least one request from the mobile device,

extracting 220 at least one identifier of a location item channel from a received request, and

transmitting 230 to the mobile device at least one location item from a location item channel whose identifier was extracted from a received request.

According to a further advantageous embodiment of the invention, the method further comprises at least the steps of

transmitting 240 instructions to a computer node for displaying a form to a user of the computer node for requesting location information from the user,

receiving 250 location information specifying a location and a location item channel identifier from the computer node, and

transmitting 260 the received location information to a mobile device as a response to a request from the mobile device indicating the location item channel identifier.

According to a further advantageous embodiment of the invention, the method further comprises at least the steps of

extracting a location indicator representing the location of the mobile device from a received request,

checking whether there exists a publicly available location item channel associated with a geographical area covering said extracted location indicator,

and if there exists such a location item channel, transmitting at least an identifier of such a location item channel in a response message to the mobile device,

The location indicator transmitted by the mobile device in a request can advantageously be a coordinate pair. However, the location indicator does not need in further embodiments of the invention to be a coordinate pair. The location indicator can also be a name of a place or for example an address.

As is clear to a man skilled in the art, the signalling of different pieces of information between a mobile device and a server node can be packaged in a multitude of ways into one or a plurality of requests and responses. Consequently, the method steps can in various embodiments of the invention be performed during an exchange of a single request from the mobile device and a single response from the server node, or for example be performed during an exchange of multiple requests and responses.

In a further embodiment according to this aspect of the invention, the method further comprises at least the steps of checking whether a received request is a service initialization request, and if a received request is a service initialization request, transmitting a mobile device identifier in a response message to the mobile device.

However, in certain embodiments of the invention, a specific service initialization request is not needed for obtaining a mobile device identifier. For example, the server node can transmit a mobile device identifier as a response to any request which does not include a mobile device identifier. In an even further embodiment of the invention, the mobile device identifier does not need to be assigned or used, since receiving location items via location item channels does not require the implementation of a mobile device identifier.

In a further embodiment according to this aspect of the invention, the method further comprises at least the steps of

determining whether a received request comprises a location item channel identifier,

and if a received request does not comprise a location item channel identifier,

creating a new location item channel, and transmitting an identifier of the created location item channel in a response message to the mobile device.

In a further embodiment according to this aspect of the invention, the method further comprises at least the steps of

receiving a request from a first mobile device indicating additional information to be associated with a location item, and

transmitting a location item having at least one piece of associated additional information to a second mobile device as a response to a request specifying the identifier of the location item channel with which the location item is associated.

This additional information can be a comment or a piece of description entered by the user of the first mobile device, or for example any other information which the user of the first mobile device wishes to add to the location information item. The location information item can include many different pieces of information, and the many different pieces of information may be different types of information, such as text, images or any other types of information.

According to a further aspect of the invention, a server node 100 for communicating location information to a plurality of mobile devices, comprising a controller 102 is provided. According to this aspect of the invention,

said controller is configured to receive at least one request from a mobile device,

said controller is configured to extract at least one identifier of a location item channel from a received request, and

said controller is configured to transmit to the mobile device at least one location item from a location item channel whose identifier was extracted from a received request.

In a further advantageous embodiment according to this aspect of the invention,

said controller is configured to transmit instructions to a computer node for displaying a form to a user of the computer node for requesting location information from the user,

said controller is configured to receive location information specifying a location and a location item channel identifier from the computer node, and

said controller is configured to transmit the received location information to a mobile device as a response to a request from the mobile device indicating the location item channel identifier.

In a further advantageous embodiment according to this aspect of the invention,

said controller is configured to extract a location indicator representing the location of the mobile device from a received request,

said controller is configured to check whether there exists a publicly available location item channel associated with a geographical area covering said extracted location indicator, and if there exists such a location item channel,

said controller is configured to transmit at least an identifier of such a location item channel in a response message to the mobile device,

According to a further aspect of the invention illustrated in FIG. 3, a computer readable medium 310 carrying one or more sequences of one or more instructions is provided. According to this aspect, when said one or more sequences of one or more instructions are executed by one or more processors, said one or more sequences of one or more instructions cause an apparatus to perform a method comprising:

receiving at least one request from the mobile device,

extracting at least one identifier of a location item channel from a received request, and

transmitting to the mobile device at least one location item from a location item channel whose identifier was extracted from a received request.

In a further embodiment according to this aspect of the invention, said one or more sequences of one or more instructions cause an apparatus to perform further method steps comprising:

transmitting instructions to a computer node for displaying a form to a user of the computer node for requesting location information from the user,

receiving location information specifying a location and a location item channel identifier from the computer node, and

transmitting the received location information to a mobile device as a response to a request from the mobile device indicating the location item channel identifier.

In a further embodiment according to this aspect of the invention, said one or more sequences of one or more instructions cause an apparatus to perform further method steps comprising:

extracting a location indicator representing the location of the mobile device from a received request,

checking whether there exists a publicly available location item channel associated with a geographical area covering said extracted location indicator, and if there exists such a location item channel,

transmitting at least an identifier of such a location item channel in a response message to the mobile device,

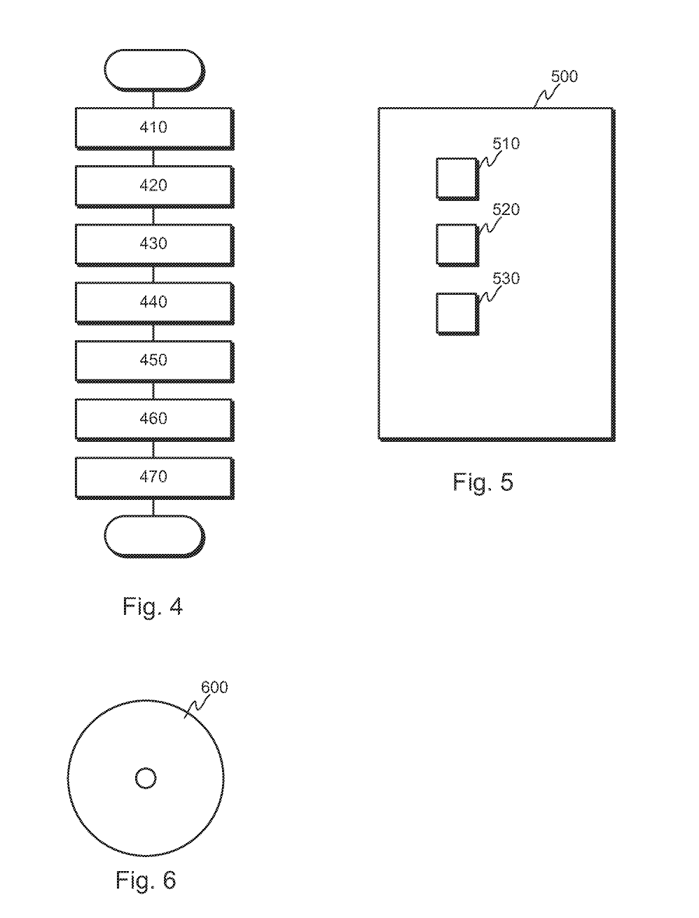

According to a further aspect of the invention illustrated in FIG. 4, a method in a mobile device for communicating location information between a server node and the mobile device is provided. According to this aspect of the invention, the method comprises at least the steps of

transmitting 410 a request to a server node, said request including at least a location indicator,

transmitting 430 an identifier of a location item channel to the server node,

receiving 440 a location item in a message from the server node, and

displaying 450 a received location item on a display of the mobile device.

The location indicator can advantageously be a coordinate pair. However, the location indicator does not need in further embodiments of the invention to be a coordinate pair. The location indicator can also be a name of a place or for example an address.

According to a further embodiment of this aspect of the invention, the method further comprises at least the steps of

receiving 420 an identifier of a location item channel in a message from the server node,

According to a further embodiment of this aspect of the invention, the method further comprises at least the steps of

receiving 460 a device identifier in a message from the server node, and

transmitting 470 the received device identifier in a subsequent message to the server node.

According to a further embodiment of this aspect of the invention, the method further comprises at least the steps of

displaying to the user of the mobile device at least one location item channel whose identifier has been received from the server node,

receiving a selection of at least one location item channel from the user of the mobile device, and

transmitting to the server node the identifier of each of the at least one location item channel selected by the user.

According to a further embodiment of this aspect of the invention, the method further comprises at least the step of periodically transmitting a location indicator and at least one identifier of a location item channel to the server node.

According to a further aspect of the invention illustrated in FIG. 5, a mobile device 500 is provided. The mobile device comprises at least one processor 510; a display 520 and at least one memory 530 including computer program code for one or more programs, the at least one memory and the computer program code configured to, with the at least one processor, cause the mobile device to perform at least the steps of

transmitting a request to a server node, said request including at least a location indicator,

receiving an identifier of a location item channel in a message from the server node,

transmitting an identifier of a location item channel to the server node,

receiving a location item in a message from the server node, and

displaying a received location item on a display of the mobile device.

In an advantageous embodiment of the invention, the mobile device can display a map, and display a received location item on the map. However, in various embodiments of the invention, the use of a map may not be necessary.

The location items can also be shown to the user as a list. The location items in the list can represent for example a number of nearest location items, or for example a number of newest location items added to a location item channel.

According to a further aspect of the invention illustrated in FIG. 6, a computer readable medium 600 carrying one or more sequences of one or more instructions which, when executed by one or more processors of a mobile device, cause the mobile device to perform a method is provided. According to this aspect of the invention, the method comprises

transmitting a request to a server node, said request including at least a location indicator,

receiving an identifier of a location item channel in a message from the server node,

transmitting an identifier of a location item channel to the server node,

receiving a location item in a message from the server node, and

displaying a received location item on a display of the mobile device.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, or a CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The term “computer readable medium” as used herein refers to any medium that participates in providing information to a processor, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as a storage device. Volatile media include, for example, a dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmit-ted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

1. A method in a server node for communicating location specific information between the server node and a mobile device, comprising at least the steps of receiving at least one request from the mobile device, extracting at least one identifier of a location item channel from a received request, and transmitting to the mobile device at least one location item from a location item channel whose identifier was extracted from a received request.

2. The method according to claim 1, further comprising at least the steps of transmitting instructions to a computer node for displaying a form to a user of the computer node for requesting location information from the user, receiving location information specifying a location and a location item channel identifier from the computer node, and transmitting the received location information to a mobile device as a response to a request from the mobile device indicating the location item channel identifier.

3. The method according to claim 1, further comprising at least the steps of extracting a location indicator representing the location of the mobile device from a received request, checking whether there exists a publicly available location item channel associated with a geographical area covering said extracted location indicator, and if there exists such a location item channel, transmitting at least an identifier of such a location item channel in a response message to the mobile device.

4. The method according to claim 1, further comprising at least the steps of checking whether a received request is a service initialization request, and if a received request is a service initialization request, transmitting a mobile device identifier in a response message to the mobile device.

5. The method according to claim 1, further comprising at least the steps of determining whether a received request comprises a location item channel identifier, and if a received request does not comprise a location item channel identifier, creating a new location item channel, and transmitting an identifier of the created location item channel in a response message to the mobile device.

6. The method according to claim 1, comprising at least the steps of receiving a request from a first mobile device indicating additional information to be associated with a location item, and transmitting a location item having at least one piece of associated additional information to a second mobile device as a response to a request specifying the identifier of the location item channel with which the location item is associated.

7. A server node for communicating location information to a plurality of mobile devices, comprising a controller, and wherein said controller is configured to receive at least one request from a mobile device, said controller is configured to extract at least one identifier of a location item channel from a received request, and said controller is configured to transmit to the mobile device at least one location item from a location item channel whose identifier was extracted from a received request.

8. The server node according to claim 7, wherein said controller is configured to transmit instructions to a computer node for displaying a form to a user of the computer node for requesting location information from the user, said controller is configured to receive location information specifying a location and a location item channel identifier from the computer node, and said controller is configured to transmit the received location information to a mobile device as a response to a request from the mobile device indicating the location item channel identifier.

9. The server node according to claim 7, wherein said controller is configured to extract a location indicator representing the location of the mobile device from a received request, said controller is configured to check whether there exists a publicly available location item channel associated with a geographical area covering said extracted location indicator, and if there exists such a location item channel, said controller is configured to transmit at least an identifier of such a location item channel in a response message to the mobile device.

10. A computer readable medium carrying one or more sequences of one or more instructions which, when executed by one or more processors, cause an apparatus to perform a method comprising: receiving at least one request from the mobile device, extracting at least one identifier of a location item channel from a received request, and transmitting to the mobile device at least one location item from a location item channel whose identifier was extracted from a received request.

11. The computer readable medium according to claim 10, carrying one or more sequences of one or more instructions which, when executed by one or more processors, further cause an apparatus to perform method steps comprising:
transmitting instructions to a computer node for displaying a form to a user of the computer node for requesting location information from the user, receiving location information specifying a location and a location item channel identifier from the computer node, and transmitting the received location information to a mobile device as a response to a request from the mobile device indicating the location item channel identifier.

12. The computer readable medium according to claim 10, carrying one or more sequences of one or more instructions which, when executed by one or more processors, further cause an apparatus to perform method steps comprising:
extracting a location indicator representing the location of the mobile device from a received request, checking whether there exists a publicly available location item channel associated with a geographical area covering said extracted location indicator, and if there exists such a location item channel, transmitting at least an identifier of such a location item channel in a response message to the mobile device.

13. A method in a mobile device for communicating location information between a server node and the mobile device, comprising at least the steps of transmitting a request to a server node, said request including at least a location indicator, transmitting an identifier of a location item channel to the server node, receiving a location item in a message from the server node, and displaying a received location item on a display of the mobile device.

14. The method of claim 13, further comprising at least the step of receiving an identifier of a location item channel in a message from the server node.

15. The method of claim 13, further comprising at least the steps of receiving a device identifier in a message from the server node, and transmitting the received device identifier in a subsequent message to the server node.

16. The method of claim 13, further comprising at least the steps of displaying to the user of the mobile device at least one location item channel whose identifier has been received from the server node, receiving a selection of at least one location item channel from the user of the mobile device, and transmitting to the server node the identifier of each of the at least one location item channel selected by the user.

17. The method of claim 13, further comprising at least the step of periodically transmitting a location indicator and at least one identifier of a location item channel to the server node.

18. A mobile device comprising: at least one processor; and at least one memory including computer program code for one or more programs, the at least one memory and the computer program code configured to, with the at least one processor, cause the mobile device to perform at least the steps of transmitting a request to a server node, said request including at least a location indicator, receiving an identifier of a location item channel in a message from the server node, transmitting an identifier of a location item channel to the server node, receiving a location item in a message from the server node, and displaying a received location item on a display of the mobile device.

19. A computer readable medium carrying one or more sequences of one or more instructions which, when executed by one or more processors of a mobile device, cause the mobile device to perform a method comprising:
transmitting a request to a server node, said request including at least a location indicator, receiving an identifier of a location item channel in a message from the server node, transmitting an identifier of a location item channel to the server node, receiving a location item in a message from the server node, and displaying a received location item on a display of the mobile device.
